(19) United States
(12) Patent Application Publication
(10) Pub. No.: US 2026/0192581 A1
(43) Pub. Date: Jul. 9, 2026

(54) TRANSPORT DEVICE, CUTTING METHOD, AND PRINTING DEVICE

(71) Applicant: SEIKO EPSON CORPORATION, TOKYO (JP)

(72) Inventor: Shohei KIMURA, SHIOJIRI-SHI (JP)

(21) Appl. No.: 19/444,660

(22) Filed: Jan. 9, 2026

(30) Foreign Application Priority Data
Jan. 9, 2025 (JP) 2025-003605

(51) Int. Cl. B41J 11/66; B41J 11/70; B41J 15/04; B41J 15/16

(52) U.S. Cl. CPC B41J 11/663; B41J 11/70; B41J 15/04; B41J 15/16

(57) ABSTRACT

A printer includes a transport section that transports a print medium fed out from a roll body, a cutting section that cuts the print medium transported by the transport section, and a control section that cuts the print medium by the cutting section when an operation of a user pulling the print medium in a transport direction is detected.

The present application is based on, and claims priority from JP Application Serial Number 2025-003605, filed January 9, 2025, the disclosure of which is hereby incorporated by reference herein in its entirety.

### BACKGROUND

### 1. Technical Field

The present disclosure relates to a transport device, a cutting method, and a printing device.

### 2. Related Art

In the related art, a technique for cutting a medium fed out from a roll body is known. For example, JP-A-2008-126585 discloses an image forming device that cuts roll paper based on a cutting speed according to a type of medium selected in an operation panel section.

In the device in which the medium is cut as in JP-A-2008-126585, the user may support the medium in order to avoid the drop of the cut medium. However, since the timing of cutting the medium is not disclosed in JP-A-2008-126585, there is a possibility that the medium is cut in a state where the user does not support the medium.

### SUMMARY

According to an aspect of the present disclosure, there is provided a transport device including: a transport section that transports a medium fed out from a roll body; a cutting section that cuts the medium transported by the transport section; and a control section that cuts the medium by the cutting section when an operation of a user pulling the medium in a transport direction is detected.

According to another aspect of the present disclosure, there is provided a cutting method using a transport device including a transport section that transports a medium fed out from a roll body, and a cutting section that cuts the medium transported by the transport section, the method including: cutting the medium by the cutting section when an operation of a user pulling the medium in a transport direction is detected.

According to still another aspect of the present disclosure, there is provided a printing device including: a transport section that transports a print medium fed out from a roll body; a printing section that performs printing on the print medium; a cutting section that cuts the print medium transported by the transport section; and a control section that cuts the print medium by the cutting section when an operation of a user pulling the print medium in a transport direction is detected.

### BRIEF DESCRIPTION OF THE DRAWINGS

FIG. 1 is a perspective view of a printer.

FIG. 2 is a schematic configuration diagram of an inside of a device main body.

FIG. 3 is a block diagram illustrating a configuration related to control of the printer.

FIG. 4 is a flowchart illustrating an operation of the printer.

FIG. 5 is a diagram illustrating an example of a first screen.

FIG. 6 is a flowchart illustrating an operation of the printer in rewinding processing.

FIG. 7 is a flowchart illustrating the operation of the printer.

FIG. 8 is a diagram illustrating an example of a second screen.

FIG. 9 is a flowchart illustrating the operation of the printer.

FIG. 10 is a diagram illustrating an example of a third screen.

### DESCRIPTION OF EMBODIMENTS

### 1. First Embodiment

First, a first embodiment will be described.

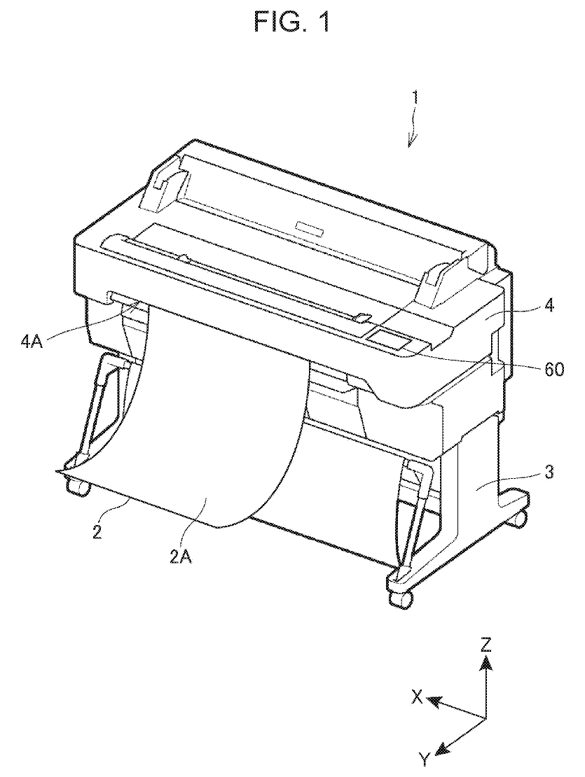

FIG. 1 is a perspective view of a printer 1.

In FIG. 1, an X axis, a Y axis, and a Z axis are illustrated as three axes orthogonal to each other. In the installation state of the printer 1, the Z axis corresponds to a vertical direction, and the X axis and the Y axis are directions along a horizontal plane. In each arrow illustrated in the axial direction, a distal end side is a "+ side" and a proximal end side is a "- side". The +Z axis direction is an upward direction. The -Z axis direction is a downward direction. The +Y axis direction is a front direction. The -Y axis direction is a rearward direction. The +X axis direction is a left direction. The -X axis direction is a right direction.

The printer 1 is an example of a "transport device" and a "printing device".

The printer 1 is a device that forms an image on a print surface 2A of a print medium 2 by discharging ink to the print medium 2. The printer 1 exemplified in the present embodiment is a large format printer that executes printing on a relatively large print medium 2 such as A0 size or B0 size according to the JIS standard.

Examples of the print medium 2 include high-quality paper, cast paper, art paper, coated paper, synthetic paper, a film made of polyethylene terephthalate (PET) or polypropylene (PP), and cloth.

The print medium is an example of a "medium".

The printer 1 has a leg portion 3 and a device main body 4 attached to the leg portion 3.

The leg portion 3 is provided with a plurality of casters at the lower end portion and supports the device main body 4 at the upper portion.

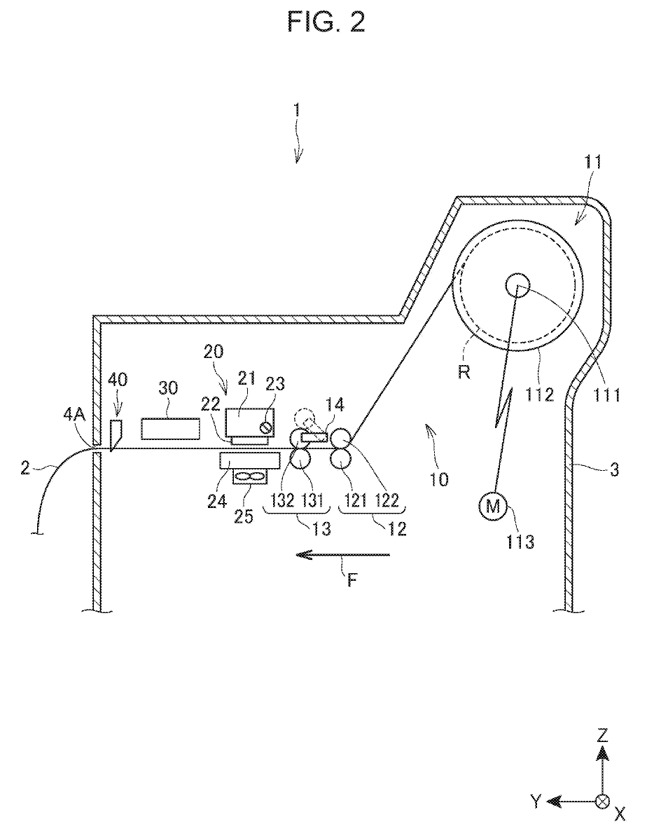

The device main body 4 includes a transport section 10, a printing section 20, a drying section 30, and a cutting section 40 inside. The configuration inside the device main body 4 will be described with reference to FIG. 2.

FIG. 2 is a schematic configuration diagram of the inside of the device main body 4.

FIG. 2 illustrates the same three axes as in FIG. 1.

As illustrated in FIG. 2, the transport section 10 includes a feeding-out section 11, a first roller pair 12, and a second roller pair 13. The transport section 10 forms a transport path for guiding the print medium 2 from the feeding-out section 11 to a discharge port 4A inside the device main body 4 by the feeding-out section 11, the first roller pair 12, and the second roller pair 13.

The feeding-out section 11 is provided at the upper rear part inside the device main body 4. The feeding-out section 11 feeds out the print medium 2 toward the printing section 20. The feeding-out section 11 includes a feeding-out shaft 111 having a cylindrical or columnar shape, a bearing 112 that rotatably supports the feeding-out shaft 111, a feeding-out motor 113 that rotates the feeding-out shaft 111, and a power transmission mechanism that transmits power of the feeding-out motor 113. The feeding-out shaft 111 holds a roll body R around which the strip-shaped print medium 2 is wound in a roll shape. The feeding-out shaft 111 rotates as the feeding-out motor 113 is driven, and feeds out the print medium 2 in the transport direction. The transport direction is a direction indicated by an arrow F, and corresponds to the +Y axis direction.

Hereinafter, the terms "upstream" and "downstream" are used as terms based on the transport direction.

The first roller pair 12 and the second roller pair 13 are provided downstream of the feeding-out section 11 and upstream of the printing section 20.

The first roller pair 12 is provided upstream of the second roller pair 13. The first roller pair 12 includes a first transport roller 121 and a first driven roller 122. The first driven roller 122 is in contact with the print medium 2 and is driven to rotate. The first transport roller 121 and the first driven roller 122 pinch the print medium 2 therebetween, and the first transport roller 121 is rotated by a drive motor (not illustrated) to transport the print medium 2 in the transport direction.

The second roller pair 13 includes a second transport roller 131 and a second driven roller 132. The second driven roller 132 is in contact with the print medium 2 and is driven to rotate. The second transport roller 131 and the second driven roller 132 pinch the print medium 2 therebetween, and the second transport roller 131 is rotated by a drive motor (not illustrated) to transport the print medium 2 in the transport direction. The position of the second driven roller 132 is changed to a release position or a pinch position by a change mechanism 14 coupled to the second driven roller 132. The change mechanism 14 includes mechanisms such as a gear for changing the position of the second driven roller 132, a gear motor for rotating the gear, and a spring that can change the pressing force of the second driven roller 132 on the print medium 2 in stages. When the second driven roller 132 is positioned at the release position, the pinching of the print medium 2 by the second roller pair 13 is released. Further, when the second driven roller 132 is positioned at the pinch position, the print medium 2 is pinched by the second roller pair 13.

The transport section 10 may include roller pairs other than the first roller pair 12 and the second roller pair 13. For example, the transport section 10 may include roller pairs provided on the downstream of the printing section 20.

The printing section 20 includes a carriage 21 and an ink jet head 22. The carriage 21 reciprocates in an intersecting direction intersecting the transport direction of the print medium 2 along a guide shaft 23 erected inside the device main body 4. In the present embodiment, the intersecting direction is a direction orthogonal to the transport direction and corresponds to the X-axis direction. The guide shaft 23 is extended in the intersecting direction of the printer 1 and is erected. Therefore, the carriage 21 reciprocates in the intersecting direction of the printer 1, that is, the X-axis direction. The ink jet head 22 is mounted on the carriage 21. Various devices may be mounted on the carriage 21 in addition to the ink jet head 22.

The ink jet head 22 has a plurality of nozzle rows which extend in the transport direction and are arranged in an intersecting direction on a surface facing the print surface 2A of the print medium 2. The ink jet head 22 of the present embodiment has four nozzle rows corresponding to each of the four colors, because the ink jet head 22 discharges cyan, magenta, yellow, and black inks. The ink jet head 22 is supplied with ink from an ink supply section (not illustrated) and discharges the ink to the print surface 2A of the print medium 2.

The ink discharged by the ink jet head 22 is not limited to the inks of the above-described colors, and may be inks such as light cyan, light magenta, orange, green, gray, light gray, white, metallic or the like. Further, the liquid discharged by the ink jet head 22 is not limited to the ink, and may be a liquid other than the ink, such as a precoat liquid.

Further, the printing section 20 includes a platen 24 and a fan 25. The platen 24 is provided at a position facing the ink jet head 22 and supports the print medium 2. The platen 24 of the present embodiment is a suction platen in which suction holes are formed in the support surface of the print medium 2. The platen 24 is driven by the fan 25 to adsorb the print medium 2 to the support surface by the suction hole.

The drying section 30 dries the ink discharged onto the print surface 2A of the print medium 2. The drying section 30 is provided on the downstream of the printing section 20. The drying section 30 is configured by, for example, a heater, and heats the print surface 2A according to the control of the control section 50 described later. The drying section 30 illustrated in FIG. 2 is configured to heat the print surface 2A from above, but the drying section 30 may heat the print medium 2 from the surface opposite to the print surface 2A.

The cutting section 40 cuts the print medium 2 according to the control of the control section 50 described later. The cutting section 40 is configured by a cutter that can reciprocate in the X-axis direction, a drive motor that reciprocates the cutter, and the like. The cutting section 40 is provided downstream of the drying section 30 and upstream of the discharge port 4A.

Next, a configuration related to the control of the printer 1 will be described.

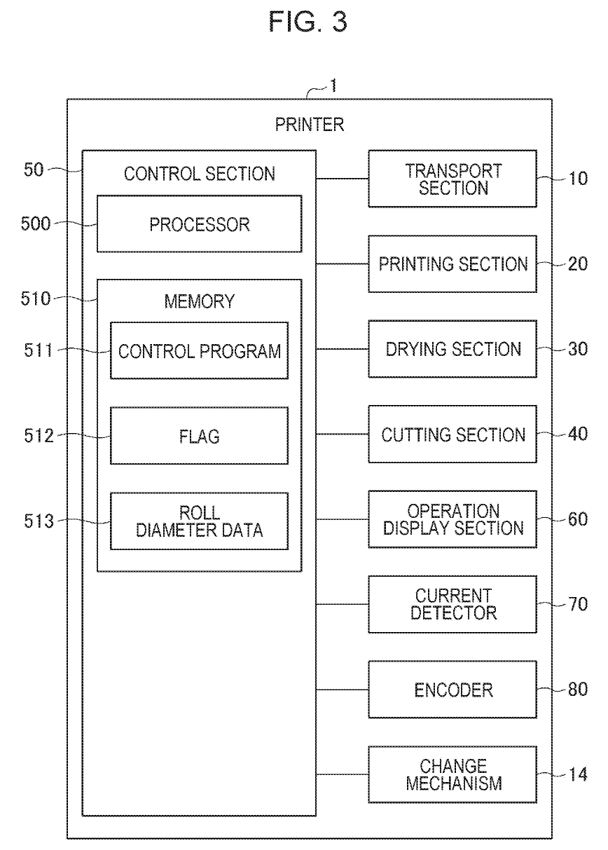

FIG. 3 is a block diagram illustrating a configuration related to the control of the printer 1.

The printer 1 includes the transport section 10, the printing section 20, the drying section 30, the cutting section 40, the control section 50, an operation display section 60, a current detector 70, an encoder 80, and a change mechanism 14.

The operation display section 60 includes an operation button and a display panel, receives an operation of the user on the printer 1, and displays various information on the display panel. The display panel included in the operation display section 60 may be a touch panel that receives a touch operation. In FIG. 1, a case where the operation display section 60 is provided on the upper surface of the device main body 4 is illustrated, but the installation position of the operation display section 60 is not limited to the position illustrated in FIG. 1.

The current detector 70 detects the current value of the feeding-out motor 113. The current detector 70 outputs a detection signal indicating the detected current value to the control section 50.

The encoder 80 detects the rotation position and the rotation direction of the feeding-out shaft 111. The encoder 80 is, for example, a rotary encoder configured with a disk-shaped scale and a photo interrupter. The encoder 80 outputs the detection signal to the control section 50.

The control section 50 includes a processor 500 such as a central processing unit (CPU) or a micro-processing unit (MPU), a memory 510, and an interface circuit for coupling to other devices and sensors. The control section 50 controls each section of the printer 1. The transport section 10, the printing section 20, the drying section 30, the cutting section 40, the operation display section 60, the current detector 70, and the encoder 80 are coupled to the control section 50.

The memory 510 is a device that stores a program or data. The memory 510 stores a control program 511, a flag 512, roll diameter data 513, data to be processed by a processor 500, and the like. The memory 510 has a non-volatile storage region. The memory 510 includes a volatile storage region and configures a work area of the processor 500. The memory 510 is configured by, for example, a read only memory (ROM) or a random access memory (RAM).

The control program 511 is a program that causes the control section 50 to execute an operation described later by the processor 500 reading the control program 511 from the memory 510 and executing the control program 511.

The flag 512 is information indicating whether or not the rotational load of the roll body R is equal to or more than a predetermined load.

The roll diameter data 513 is data indicating the diameter of the roll body R held by the feeding-out shaft 111. The diameter of the roll body R indicated by the roll diameter data 513 may be a radius or a diameter. The diameter of the roll body R indicated by the roll diameter data 513 is appropriately updated according to the feeding-out of the print medium 2 and the rewinding of the print medium 2.

When the processor 500 executes the control program 511, the control section 50 drives the feeding-out motor 113, the drive motor that rotates the first transport roller 121, the drive motor that rotates the second transport roller 131, and the like. As a result, the control section 50 feeds out the print medium 2 from the roll body R and transports the fed-out print medium 2 in the transport direction. Further, the control section 50 rewinds the print medium 2 fed out from the roll body R to the roll body R.

When the processor 500 executes the control program 511, the control section 50 drives the drive motor that causes the carriage 21 to scan and also drives the ink jet head 22. As a result, the control section 50 performs printing on the print medium 2 supported by the platen 24.

When the processor 500 executes the control program 511, the control section 50 drives the drying section 30 to dry the ink discharged to the print surface 2A of the print medium 2.

When the processor 500 executes the control program 511, the control section 50 drives the drive motor that reciprocates the cutter to cut the print medium 2.

When the processor 500 executes the control program 511, the control section 50 causes the operation display section 60 to display various information.

When the processor 500 executes the control program 511, the control section 50 receives various operations from the user via the operation display section 60.

When the processor 500 executes the control program 511, the control section 50 detects a pull-out operation. The pull-out operation is an operation of the user and is an operation of pulling the print medium 2 discharged from the discharge port 4A in the transport direction. In the present embodiment, the control section 50 detects the pull-out operation when the rotational load of the roll body R is equal to or more than a predetermined load while the print medium 2 is being rewound by the transport section 10. More specifically, the control section 50 detects the pull-out operation when the current value detected by the current detector 70 becomes equal to or more than a predetermined value corresponding to a predetermined load during the rewinding of the print medium 2.

Next, the operation of the printer 1 according to the present embodiment will be described.

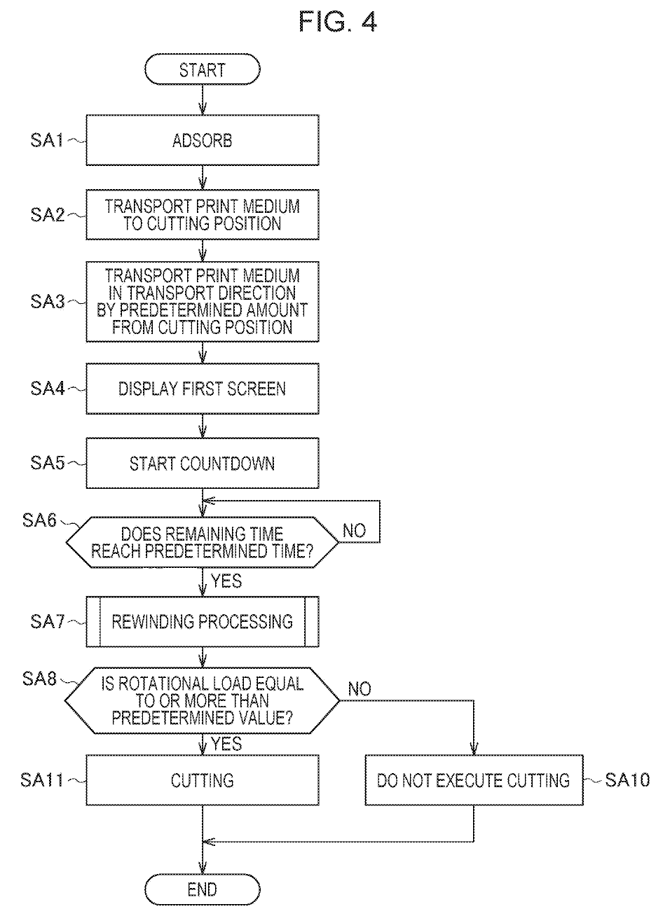

FIG. 4 is a flowchart illustrating the operation of the printer 1.

The operation in FIG. 4 is an operation related to the cutting of the print medium 2, and is an operation started when the printing by the printing section 20 and the drying by the drying section 30 end.

At the operation start point in FIG. 4, the flag 512 indicates that the rotational load of the roll body R is not equal to or more than the predetermined load.

The control section 50 drives the fan 25 included in the printing section 20 to adsorb the print medium 2 to the platen 24 (Step SA1).

Next, the control section 50 causes the transport section 10 to transport the printed print medium 2 to the cutting position (Step SA2). When the Step SA2 is described in detail, the control section 50 transports the print medium 2 in the transport direction until the upstream end of the print surface 2A is positioned at the cutting position or is positioned downstream of the cutting position.

Next, the control section 50 causes the transport section 10 to transport the print medium 2 in the transport direction by a predetermined amount from the cutting position (Step SA3). An example of the predetermined amount is 5 mm (millimeters). The predetermined amount is not limited to 5 mm, and may be smaller than 5 mm or larger than 5 mm.

Next, the control section 50 causes the operation display section to display a first screen G1 (Step SA4), and starts the countdown until the print medium 2 is cut (Step SA5).

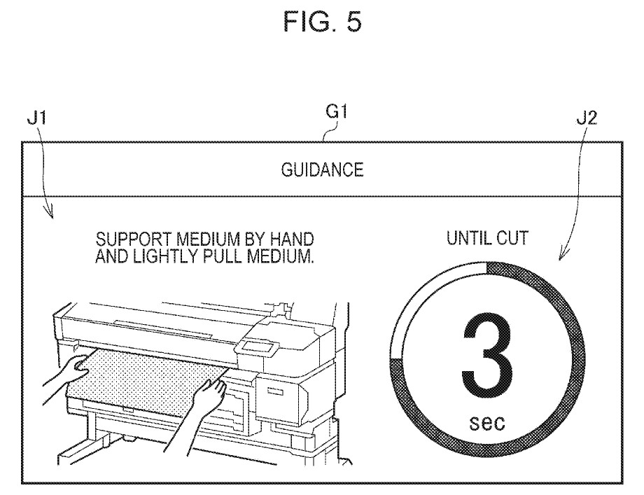

FIG. 5 is a diagram illustrating an example of the first screen G1.

The first screen G1 displays first guidance information J1 and remaining time information J2.

The first guidance information J1 is information that guides the user to pull the print medium 2 while manually supporting the print medium 2. In FIG. 5, a character string of "support the medium by hand and lightly pull the medium." and a drawing schematically illustrating the content of the character string are the first guidance information J1.

The remaining time information J2 is information indicating the remaining time until the print medium 2 is cut. The remaining time indicated by the remaining time information J2 is reduced each time the countdown is performed.

The control section 50 determines whether or not the remaining time until the print medium 2 is cut reaches a predetermined time (Step SA6). Examples of the predetermined time include 2 seconds. The predetermined time is not limited to 2 seconds, and may be shorter than 2 seconds or longer than 2 seconds.

When it is determined that the remaining time until the cutting of the print medium 2 has not reached the predetermined time (Step SA6: NO), the control section 50 performs the determination in Step SA6 again.

Meanwhile, when it is determined that the remaining time until the print medium 2 is cut has reached the predetermined time (Step SA6: YES), the control section 50 executes the rewinding processing (Step SA7).

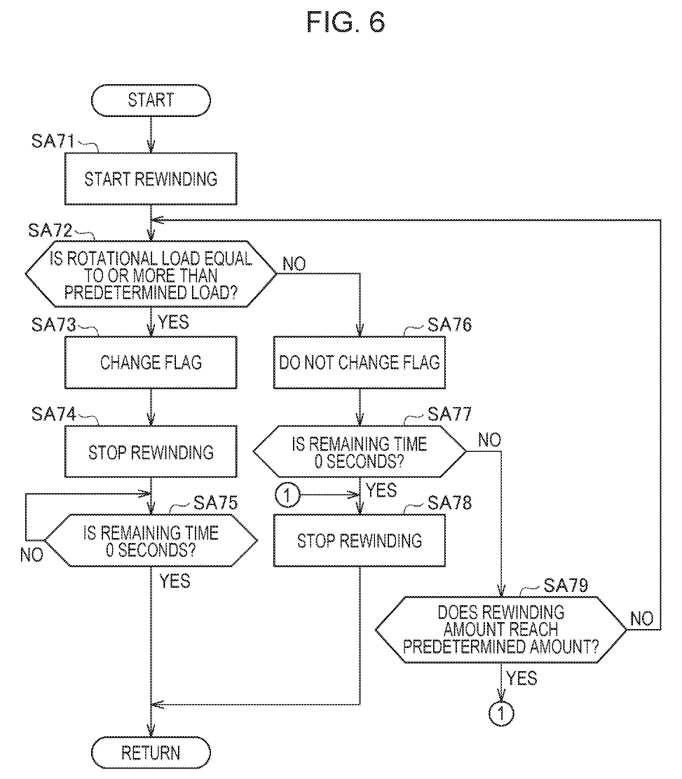

FIG. 6 is a flowchart illustrating an operation of the printer 1 in the rewinding processing.

The control section 50 causes the transport section 10 to start rewinding the print medium 2 (Step SA71). When the Step SA71 is described in detail, the control section 50 starts rewinding the print medium 2 at a speed lower than the speed at which the print medium 2 is transported in the transport direction. The speed of rewinding the print medium 2 is a speed at which a predetermined amount is transported from the cutting position within the remaining time until the print medium 2 is cut.

Next, the control section 50 determines whether or not the rotational load of the roll body R is equal to or more than a predetermined load (Step SA72).

When it is determined that the rotational load of the roll body R is equal to or more than the predetermined load (Step SA72: YES), the control section 50 changes the flag 512 stored in the memory 510 to the flag 512 indicating that the rotational load of the roll body R is equal to or more than the predetermined load (Step SA73).

Next, the control section 50 stops the transport section 10 from rewinding the print medium 2 (Step SA74).

Next, the control section 50 determines whether or not the remaining time until the print medium 2 is cut is 0 seconds (Step SA75). When it is determined that the remaining time until the print medium 2 is cut is not 0 seconds (Step SA75: NO), the control section 50 performs the determination in Step SA75 again. Meanwhile, when it is determined that the remaining time until the print medium 2 is cut is 0 seconds, the control section 50 ends the rewinding processing.

Returning to the description of Step SA72, when it is determined that the rotational load of the roll body R is not equal to or more than the predetermined load (Step SA72: NO), the control section 50 does not change the flag 512 stored in the memory 510 (Step SA76).

Next, the control section 50 determines whether or not the remaining time until the print medium 2 is cut is 0 seconds (Step SA77).

When it is determined that the remaining time until the print medium 2 is cut is 0 seconds (Step SA77: YES), the control section 50 stops the transport section 10 from rewinding the print medium 2 (Step SA78), and ends the rewinding processing.

Meanwhile, when it is determined that the remaining time until the print medium 2 is cut is not 0 seconds (Step SA75: NO), the control section 50 determines whether or not the rewinding amount of the print medium 2 reaches the predetermined amount transported in Step SA3 (Step SA79). In Step SA79, the control section 50 grasps the rewinding amount of the print medium 2 based on the roll diameter data 513 and the detection signal from the encoder 80.

When it is determined that the rewinding amount of the print medium 2 reaches the predetermined amount (Step SA79: YES), the control section 50 stops the transport section 10 from the rewinding the print medium 2 (Step SA78) and ends the rewinding processing.

Meanwhile, when it is determined that the rewinding amount of the print medium 2 does not reach the predetermined amount (Step SA79: NO), the control section 50 returns the processing to Step SA72.

Returning to the description of the flowchart illustrated in FIG. 4, when the rewinding processing ends, the control section 50 ends the countdown until the print medium 2 is cut (Step SA8).

Next, the control section 50 determines whether or not the flag 512 stored in the memory 510 indicates that the rotational load of the roll body R is equal to or more than a predetermined load (Step SA9).

When it is determined that the flag 512 indicates that the rotational load of the roll body R is less than the predetermined load (Step SA9: NO), the control section 50 does not execute the cutting of the print medium 2 (Step SA10).

Meanwhile, when it is determined that the flag 512 indicates that the rotational load of the roll body R is equal to or more than the predetermined load (Step SA9: YES), the control section 50 cuts the print medium 2 by the cutting section 40 (Step SA11).

When the cutting of the print medium 2 is not executed, the control section 50 may start the flowchart illustrated in FIG. 4 again, or may not start the flowchart illustrated in FIG. 4 until the cutting execution instruction is performed on the operation display section 60.

As described above, the printer 1 includes the transport section 10 that transports the print medium 2 fed out from the roll body R. Further, the printer 1 includes the cutting section 40 that cuts the print medium 2 transported by the transport section 10. Further, the printer 1 includes the control section 50 that cuts the print medium 2 by the cutting section 40 when the pull-out operation is detected.

Accordingly, since the print medium 2 is cut when the pull-out operation is detected, the print medium 2 can be cut in a state where the user supports the print medium 2. Further, since the user can cut the print medium 2 in a state of supporting the print medium 2, the print medium 2 can be prevented from falling from the printer 1.

The control section 50 detects the pull-out operation based on the rotational load of the roll body R.

As a result, by detecting the pull-out operation based on the rotational load of the roll body R, the detection of the pull-out operation can be accurately performed. Therefore, the user can appropriately cut the print medium 2 in a state where the user is supporting the print medium 2.

The transport section 10 includes the feeding-out section 11 that rotates the roll body R to feed out the print medium 2. The control section 50 rewinds the print medium 2 onto the roll body R by the feeding-out section 11. The control section 50 detects the pull-out operation based on the rotational load of the roll body R while the print medium 2 is being rewound.

As a result, since the pull-out operation is detected based on the rotational load of the roll body R while the print medium 2 is being rewound, the operation of pulling in the direction opposite to the rewinding can be quickly detected. Therefore, the time for rewinding the print medium 2 can be shortened, and the time from when the user supports the print medium 2 to when the print medium 2 is cut can be shortened.

When the rotational load of the roll body R is equal to or more than the predetermined load, the control section 50 stops the rewinding of the print medium 2.

As a result, an increase in the tension applied to the print medium 2 can be suppressed by the pull-out operation and the rewinding of the print medium 2. Therefore, the print medium 2 can be cut while suppressing the influence of the pull-out operation on the print medium 2.

The control section 50 rewinds the print medium 2 at a speed lower than the speed when the print medium 2 is transported in the transport direction.

As a result, an increase in the tension applied to the print medium 2 can be suppressed by the pull-out operation and the rewinding of the print medium 2. Therefore, the print medium 2 can be cut while suppressing the influence of the pull-out operation on the print medium 2.

In the cutting method by the printer 1, when the detection of the pull-out is performed, the print medium 2 is cut by the cutting section 40.

As a result, the same effect as that of the printer 1 described above is achieved.

### 2. Second Embodiment

Next, a second embodiment will be described.

Comparing the second embodiment with the first embodiment, in the second embodiment, the memory 510 does not store the flag 512.

In addition, in comparison between the second embodiment and the first embodiment, the detection method of the pull-out operation is different in the second embodiment. In the second embodiment, the control section 50 detects the pull-out operation based on the rotational load of the roll body R while executing the control of not feeding out the print medium 2 from the roll body R. More specifically, the control section 50 detects the pull-out operation when the torque in the direction of rewinding the print medium 2 is generated in the roll body R while executing the control of not feeding out the print medium 2 from the roll body R. More specifically, the control section 50 detects the pull-out operation when the current value detected by the current detector 70 is equal to or more than a predetermined value while executing the control of not feeding out the print medium 2.

Further, in comparison between the second embodiment and the first embodiment, the operation related to the cutting of the print medium 2 is different in the second embodiment.

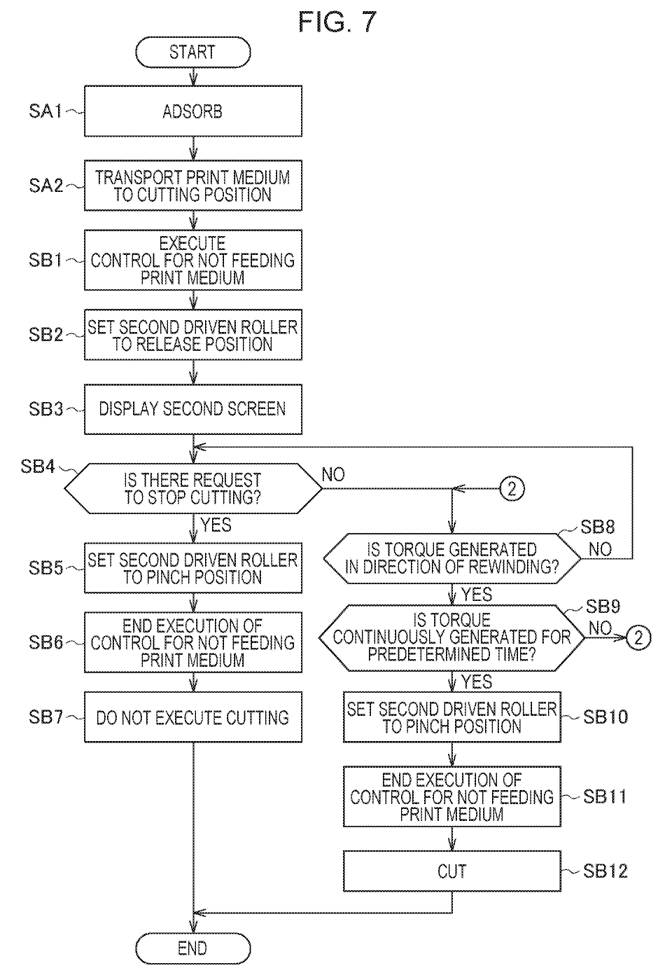

FIG. 7 is a view illustrating an operation of the printer 1 according to the second embodiment.

The operation in FIG. 7 is an operation related to the cutting of the print medium 2, and is an operation started when the printing by the printing section 20 and the drying by the drying section 30 end.

In the flowchart illustrated in FIG. 7, the same step as the step in the flowchart illustrated in FIG. 4 is given the same step number, and the detailed description thereof will be appropriately omitted.

When the transport section 10 transports the print medium 2 to the cutting position, the control section 50 starts the execution of the control for not feeding out the print medium 2 from the roll body R (Step SB1).

The control section 50 controls the feeding-out motor 113 such that the scale position detected by the encoder 80 does not change based on the detection signal of the encoder 80. As a result, the control section 50 executes the control not to feed out the print medium 2 from the roll body R.

Next, the control section 50 sets the position of the second driven roller 132 to the release position by the change mechanism 14 (Step SB2).

Next, the control section 50 causes the operation display section 60 to display a second screen G2 (Step SB3).

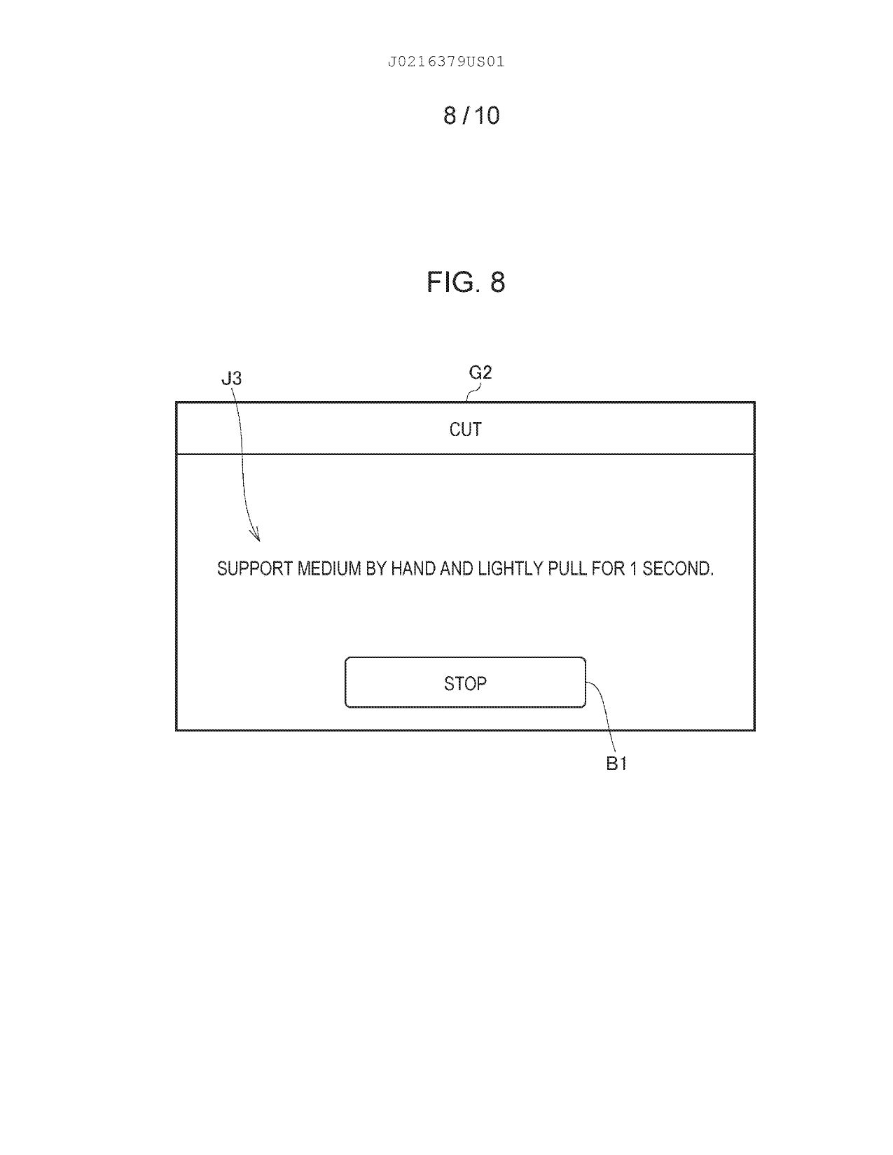

FIG. 8 is a diagram illustrating an example of the second screen G2.

The second screen G2 displays second guidance information J3 and a stop button B1.

The second guidance information J3 is information for guiding the user to pull the print medium 2 for a predetermined time in a state where the print medium 2 is supported by hand. In FIG. 8, a character string of "support the medium by hand and lightly pull for 1 second." is the second guidance information J3.

The stop button B1 is a software button for receiving an instruction from the user to stop cutting the print medium 2.

Returning to the description of the flowchart illustrated in FIG. 7, the control section 50 determines whether or not there is a request from the user to stop the cutting of the print medium 2 (Step SB4). In Step SB4, when the operation of the stop button B1 is received, the control section 50 performs a positive determination in Step SB4, and when the operation of the stop button B1 is not received, the control section 50 performs a negative determination in Step SB4.

When it is determined that the user has requested to stop the cutting of the print medium 2 (Step SB4: YES), the control section 50 sets the position of the second driven roller 132 to the pinch position (Step SB5) and ends the execution of the control for not feeding out the print medium 2 (Step SB6). Then, the control section 50 does not execute the cutting of the print medium 2 (Step SB7).

Returning to the description of Step SB3, when it is determined that there is no request for the user to stop cutting the print medium 2 (Step SB3: NO), the control section 50 determines whether or not the torque in the direction of rewinding the print medium 2 is generated in the roll body R (Step SB8).

When it is determined that the torque in the direction of rewinding the print medium 2 is not generated in the roll body R (Step SB8: NO), the control section 50 returns the processing to Step SB4.

Meanwhile, when it is determined that the torque in the direction of rewinding the print medium 2 is generated in the roll body R (Step SB8: YES), the control section 50 determines whether or not the torque in the direction of rewinding the print medium 2 is continuously generated in the roll body R for a predetermined time (Step SB9). An example of the predetermined time is 1 second. The predetermined time is not limited to 1 second, and may be shorter than 1 second or longer than 1 second. However, it is preferable that the predetermined time is the same as the number of seconds displayed on the second screen G2.

When it is determined that the torque in the direction of rewinding the print medium 2 is not continuously generated in the roll body R for the predetermined time (Step SB9: NO), the control section 50 returns the processing to Step SB8.

Meanwhile, when it is determined that the torque in the direction of rewinding the print medium 2 is continuously generated in the roll body R for the predetermined time (Step SB9: YES), the control section 50 sets the position of the second driven roller 132 to the pinch position (Step SB10). The control section 50 ends the execution of the control for not feeding out the print medium 2 (Step SB11), and the cutting section 40 cuts the print medium 2 (Step SB12).

As described above, the control section 50 executes the control of not feeding out the print medium 2 from the roll body R. When the torque in the direction of rewinding the print medium 2 is generated in the roll body R while the control section 50 executes the control of not feeding out the print medium 2 from the roll body R, the control section 50 detects the pull-out operation and cuts the print medium 2.

As a result, the detection of the pull-out operation can be performed accurately. Therefore, the user can appropriately cut the print medium 2 in a state where the user is supporting the print medium 2.

When the torque in the direction of rewinding the print medium 2 continues to be generated in the roll body R for a predetermined time, the control section 50 cuts the print medium 2.

As a result, the detection of the pull-out operation can be performed more accurately. Therefore, the user can more appropriately cut the print medium 2 in a state of supporting the print medium 2.

### 3. Third Embodiment

Next, a third embodiment will be described.

Comparing the third embodiment with the first embodiment, in the third embodiment, the memory 510 does not store the flag 512.

In addition, in comparison between the third embodiment and the first embodiment, the detection method of the pull-out operation is different in the third embodiment. In the third embodiment, the control section 50 detects the pull-out operation when the print medium 2 is pulled out by a predetermined amount in the transport direction. More specifically, the control section 50 calculates the feeding-out amount of the print medium 2 based on the detection signal input from the encoder 80 and the roll diameter data 513, and detects the pull-out operation when the calculated feeding-out amount is equal to or more than a predetermined amount.

In addition, in comparison between the third embodiment and the first embodiment, the operation related to the cutting of the print medium 2 is different in the third embodiment.

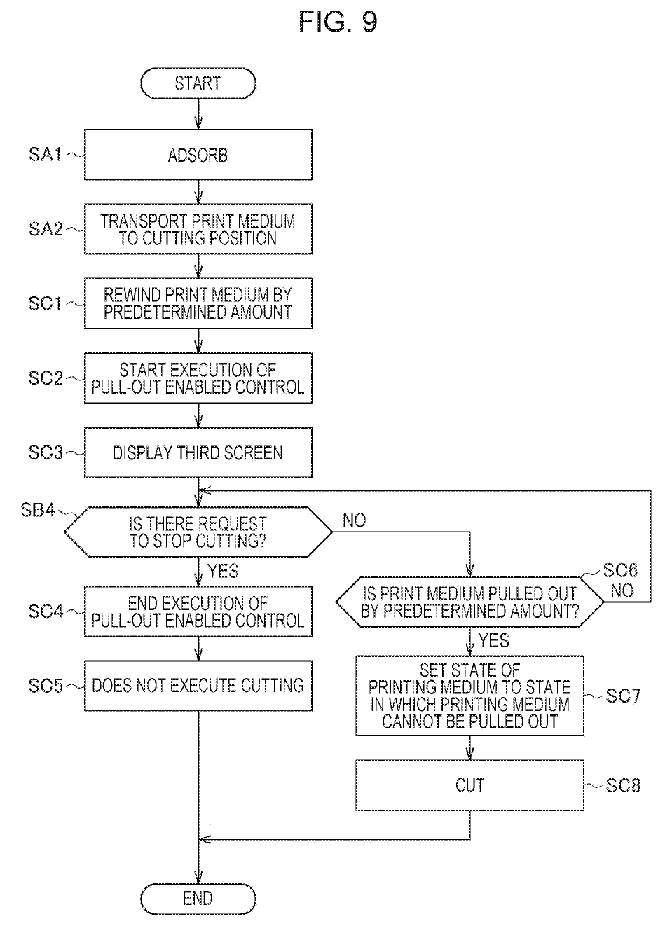

FIG. 9 is a view illustrating the operation of the printer 1 according to the third embodiment.

The operation in FIG. 9 is an operation related to the cutting of the print medium 2, and is an operation started when the printing by the printing section 20 and the drying by the drying section 30 end.

In the flowchart illustrated in FIG. 9, the same step numbers are given to the same steps as those in the flowchart illustrated in FIG. 4, and the detailed description thereof will be appropriately omitted.

When the transport section 10 transports the print medium 2 to the cutting position, the control section 50 rewinds the print medium 2 by a predetermined amount by the transport section 10 (Step SC1). An example of the predetermined amount is 5 mm (millimeters). The predetermined amount is not limited to 5 mm, and may be smaller than 5 mm or larger than 5 mm. However, the predetermined amount is preferably an amount in which the upstream end of the print surface 2A is not transported to the drying section 30.

Next, the control section 50 starts the execution of pull-out enabled control (Step SC2).

The pull-out enabled control is a control that allows the user to pull out the print medium 2 with an appropriate force at an appropriate speed. In the pull-out enabled control, for example, the control section 50 sets the pressing force of the second driven roller 132 to be stronger than the pressing force at the time of printing execution, and does not set the pressing force of the second driven roller 132 to the strongest pressing force. Further, in the pull-out enabled control, for example, when the amount of torque in the feeding-out direction generated in the roll body R is equal to or more than a predetermined amount, the control section 50 controls the feeding-out motor 113 so that the print medium 2 can be fed out.

Next, the control section 50 causes the operation display section 60 to display a third screen G3 (Step SC3).

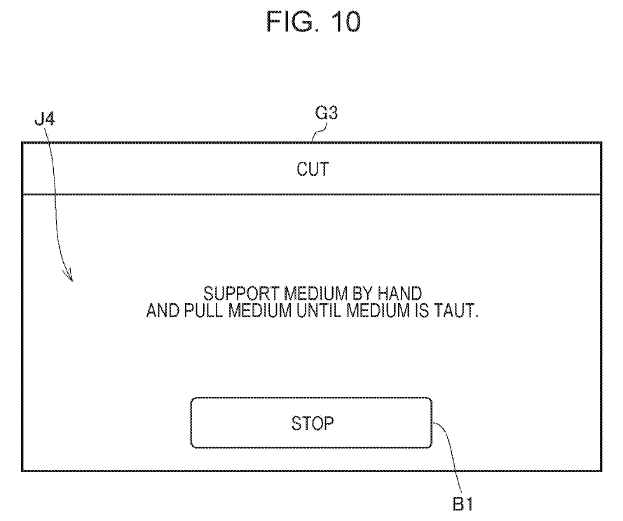

FIG. 10 is a diagram illustrating an example of the third screen G3.

The third screen G3 displays a third guidance information J4 and a stop button B1.

The third guidance information J4 is information for guiding the user to pull the print medium 2 in a state where the print medium 2 is supported by hand. In FIG. 10, the character string of "support the medium by hand and pull medium until the medium is taut" is the third guidance information J4.

Returning to the description of the flowchart illustrated in FIG. 7, when it is determined that the user has requested to stop the cutting of the print medium 2 (Step SB4: YES), the control section 50 ends the execution of the pull-out enabled control (Step SC4). Then, the control section 50 does not execute the cutting of the print medium 2 (Step SC5).

Returning to the description of Step SB3, when it is determined that there is no request for the user to stop the cutting of the print medium 2 (Step SB4: NO), the control section 50 determines whether or not the print medium 2 is pulled out by a predetermined amount in the transport direction (Step SC6). That is, in Step SC6, the control section 50 determines whether or not the feeding-out amount of the print medium 2 has reached a predetermined amount. The control section 50 grasps the feeding-out amount of the print medium 2 based on the detection signal of the encoder 80 and the roll diameter data 513.

When it is determined that the print medium 2 is not pulled out by a predetermined amount in the transport direction (Step SC6: NO), the control section 50 returns the processing to Step SB4.

Meanwhile, when it is determined that the print medium 2 is pulled out by a predetermined amount in the transport direction (Step SC6: YES), the control section 50 sets the state of the print medium 2 to a state in which the print medium 2 cannot be pulled in the transport direction (Step SC7). To give more details about Step SC7, the control section 50 changes the pressing force of the second driven roller 132 to the strongest pressing force, or holds the feeding-out motor 113 so that the print medium 2 is not fed out.

Next, the control section 50 causes the cutting section 40 to cut the print medium 2 (Step SC8).

As described above, the control section 50 detects the pull-out operation based on the feeding-out amount of the print medium 2 fed out from the roll body R.

As a result, the detection of the pull-out operation can be performed accurately. Therefore, the print medium 2 can be appropriately cut in a state where the print medium 2 is supported.

When the feeding-out amount of the print medium 2 reaches the predetermined amount, the control section 50 detects the pull-out operation and cuts the print medium 2.

As a result, the pull-out operation can be detected more accurately. Therefore, the print medium 2 can be more appropriately cut in a state where the print medium 2 is supported.

When the feeding-out amount of the print medium 2 reaches the predetermined amount, the control section 50 sets the print medium 2 in a state where the state of the print medium 2 cannot be pulled in the transport direction and cuts the print medium 2.

As a result, the unnecessary consumption of the print medium 2 due to the unnecessary pulling out can be suppressed.

### 4. Other Embodiments

The above-described embodiments are the preferred embodiments of the present disclosure. However, various modifications can be made without being limited to the above- described embodiments within the spirit of the present disclosure.

In another embodiment, the printer 1 may include a winding portion that winds the print medium 2 discharged from the discharge port 4A.

In another embodiment, the ink jet head 22 may be a line head type print head.

In another embodiment, the printing method of the printer 1 may be a method other than the ink jet method such as an electronic transfer method.

In another embodiment, a cutter may be mounted on the carriage 21, and the print medium 2 may be cut by the movement of the carriage 21.

In another embodiment, the number and arrangement of the roller pairs forming the transport path and the motors driving the roller pairs are not limited to the above-described embodiments. The number and arrangement of the roller pairs and the motors can be appropriately changed according to the size of the print medium 2.

In the above-described embodiment, the large format printer is exemplified as the "printing device". In another embodiment, the "printing device" may be a device that feeds out the print medium 2 from the roll body R and cuts the print medium 2. For example, in another embodiment, the "printing device" may be a label printer.

In the above-described embodiment, a device having a printing function is exemplified as the "printing device". In another embodiment, the "printing device" may be a device having a function other than the printing function such as a scanning function.

In the above-described embodiment, the printer 1 is exemplified as the "transport device". However, the "transport device" is not limited to the printer 1, and may be a device that does not include the printing section 20, the drying section 30, or the like. That is, the "transport device" may be a device that transports the medium fed out from the roll body R and can cut the transported medium.

The functions of the control section 50 may be realized by a plurality of processors or semiconductor chips.

In addition, the configuration of the printer 1 illustrated in FIG. 3 illustrates a functional configuration, and a specific mounting embodiment is not particularly limited. That is, it is not always necessary to mount hardware that individually corresponds to each functional section, and a configuration may be adopted in which one processor realizes a plurality of functions by executing a program. In addition, in the above embodiments, a part of the function realized by the software may be realized by the hardware, and a part of the function realized by the hardware may be realized by the software. In addition, specific detailed configurations of other sections of the printer 1 can be optionally changed without departing from the spirit of the present disclosure.

In addition, the processing units of the flowcharts illustrated in FIGS. 4, 6, 7, and 9 are divided according to the main processing contents in order to facilitate understanding of the processing of each section of the printer 1, and the present disclosure is not limited by the method or name of the division of the processing unit. The processing content may be divided into many step units. Further, one step unit may be divided to include a large amount of processing. Further, the order of the steps may be appropriately changed within a range that does not interfere with the spirit of the present disclosure.

What is claimed is:

1. A transport device comprising:
a transport section that transports a medium fed out from a roll body;
a cutting section that cuts the medium transported by the transport section; and
a control section that cuts the medium by the cutting section when an operation of a user pulling the medium in a transport direction is detected.

2. The transport device according to claim 1, wherein
the control section detects the operation of the user based on a rotational load of the roll body.

3. The transport device according to claim 2, wherein
the transport section includes a feeding-out section that rotates the roll body to feed out the medium, and
the control section
rewinds the medium onto the roll body by the feeding-out section, and
detects the operation of the user based on the rotational load of the roll body while the medium is rewound.

4. The transport device according to claim 3, wherein
the control section stops rewinding of the medium when the rotational load of the roll body is equal to or more than a predetermined load.

5. The transport device according to claim 3, wherein
the control section rewinds the medium at a speed lower than a speed when the medium is transported in the transport direction.

6. The transport device according to claim 2, wherein
the control section executes control not to feed out the medium from the roll body, and
when a torque in a direction of rewinding the medium is generated in the roll body while executing the control not to feed out the medium, the control section detects the operation of the user and cuts the medium.

7. The transport device according to claim 6, wherein
the control section cuts the medium when the torque in the direction of rewinding the medium continues to be generated in the roll body for a predetermined time.

8. The transport device according to claim 1, wherein
the control section detects the operation of the user based on a feeding-out amount of the medium fed out from the roll body.

9. The transport device according to claim 8, wherein
when the feeding-out amount of the medium reaches a predetermined amount, the control section detects the operation of the user and cuts the medium.

10. The transport device according to claim 9, wherein
when the feeding-out amount of the medium reaches the predetermined amount, the control section sets the medium in a state in which the medium cannot be pulled in the transport direction and cuts the medium.

11. A cutting method using a transport device including a transport section that transports a medium fed out from a roll body, and a cutting section that cuts the medium transported by the transport section, the method comprising:
cutting the medium by the cutting section when an operation of a user pulling the medium in a transport direction is detected.

12. A printing device comprising:
a transport section that transports a print medium fed out from a roll body;
a printing section that performs printing on the print medium;
a cutting section that cuts the print medium transported by the transport section; and
a control section that cuts the print medium by the cutting section when an operation of a user pulling the print medium in a transport direction is detected.
